(19) United States
(12) Patent Application Publication
(10) Pub. No.: US 2024/0215052 A1
(43) Pub. Date: Jun. 27, 2024

(54) METHOD FOR TRANSMITTING POINT-TO-MULTIPOINT CONFIGURATION AND APPARATUS THEREOF, AND READABLE STORAGE MEDIUM

(71) Applicant: JRD COMMUNICATION (SHENZHEN) LTD., Shenzhen, Guangdong (CN)

(72) Inventors: Ahmed MOHAMMED MIKAEIL, Shenzhen, Guangdong (CN); Jia SHENG, Shenzhen, Guangdong (CN)

(73) Assignee: JRD COMMUNICATION (SHENZHEN) LTD., Shenzhen, Guangdong (CN)

(21) Appl. No.: 18/557,060

(22) PCT Filed: May 11, 2021
(86) PCT No.: PCT/CN2021/093177

§ 371 Date: Oct. 25, 2023

(51) Int. Cl. H04W 72/30; H04W 68/02; H04W 72/0457; H04W 72/12; H04W 72/231

(52) U.S. Cl. CPC H04W 72/30; H04W 68/02; H04W 72/0457; H04W 72/12; H04W 72/231

(57) ABSTRACT

A method for transmitting a point-to-multipoint (PTM) configuration executable in a base station includes assigning radio resources for the PTM configuration; wherein the PTM configuration includes scheduling information of a multicast control channel (MCCH) and/or a multicast transmission channel (MTCH); determining a scheduling configuration for the PTM configuration based on the radio resources; wherein the scheduling configuration includes a first control resource set (CORESET) and a combination of scheduling parameters for scheduling the PTM configuration and a configuration of each of at least one other common control channel; the at least one other common control channel includes at least one of a broadcast control channel (BCCH) and a paging control channel (PCCH).

### TECHNICAL FIELD

The present disclosure relates to the field of communication technologies, and in particular to a method for transmitting a point-to-multipoint (PTM) configuration and an apparatus thereof, and a readable storage medium.

### BACKGROUND

With the rapid development of the Internet and the popularity of large-screen multifunctional user equipments (UEs), a large number of mobile data multimedia services and various high-bandwidth multimedia services have emerged, such as video conferencing, TV broadcasting, video on demand, advertising, online education, interactive games, etc. These services meet the needs of mobile users for multiple services and also bring new business growth points for mobile operators. These mobile data multimedia services require multiple users to be able to receive the same data at the same time, and are characterized by large data volume, long duration and insensitive time delay compared with general data services.

In order to efficiently utilize mobile network resources, a third generation partnership project (3GPP) proposed a multicast/broadcast service (MBS). The service is a technology that transmits data from one data source to multiple target user equipments, realizing the sharing of network (including core and access networks) resources and improving the utilization of network resources (especially air interface resources). It can be seen that the MBS is essentially a point-to-multipoint (PTM) information configuration service.

Multicast/Broadcast Services (MBS) is expected to cover diversity of fifth generation (5G) applications and services ranging from public safety, mission critical, vehicle to everything (V2X), transparent Internet Protocol version 4 (IPv4)/IPv6 multicast delivery, Internet Protocol Television (IPTV), software delivery over wireless to group communications and Internet of Things (IOT) applications.

### SUMMARY OF THE DISCLOSURE

In a first aspect, the present disclosure provides a method for transmitting a point-to-multipoint (PTM) configuration executable in a base station, including: assigning radio resources for the PTM configuration; wherein the PTM configuration includes scheduling information of a multicast control channel (MCCH) and/or a multicast transmission channel (MTCH); determining a scheduling configuration for the PTM configuration based on the radio resources; wherein the scheduling configuration includes a first control resource set (CORESET) and a combination of scheduling parameters for scheduling the PTM configuration and a configuration of each of at least one other common control channel; the at least one other common control channel includes at least one of a broadcast control channel (BCCH) and a paging control channel (PCCH); the combination of scheduling parameters includes scheduling parameters of the PTM configuration and scheduling parameters of the configuration of each of the at least one other common control channel, the scheduling parameters including at least one set of a search space and a downlink control information (DCI) configuration; and transmitting at least one system information block (SIB) carrying the scheduling configuration to user equipments, and transmitting the PTM configuration to the user equipments according to the scheduling configuration.

In a second aspect, the present disclosure provides a method for transmitting a point-to-multipoint (PTM) configuration executable in user equipments, including: receiving at least one system information block (SIB) carrying a scheduling configuration; reading the at least one SIB to obtain the scheduling configuration; wherein the scheduling configuration includes a first control resource set (CORESET) and a combination of scheduling parameters for scheduling the PTM configuration and a configuration of each of at least one other common control channel; the at least one other common control channel includes at least one of a broadcast control channel (BCCH) and a paging control channel (PCCH); the combination of scheduling parameters includes scheduling parameters of the PTM configuration and scheduling parameters of the configuration of each of the at least one other common control channel, the scheduling parameters including at least one set of a search space and a downlink control information (DCI) configuration; and based on the DCI configuration in the scheduling parameters of the PTM configuration, monitoring a corresponding search space of the PTM configuration to receive the PTM configuration; wherein the PTM configuration includes scheduling information of a multicast control channel (MCCH) and/or a multicast transmission channel (MTCH).

In a third aspect, the present disclosure provides an apparatus for transmitting a point-to-multipoint (PTM) configuration, including a processor and a communication circuit connected to the processor; wherein the processor is configured to execute instructions to perform the method in the first aspect.

In a fourth aspect, the present disclosure provides an apparatus for transmitting a point-to-multipoint (PTM) configuration, including a processor and a communication circuit connected to the processor; wherein the processor is configured to execute instructions to perform the method in the second aspect.

In a fifth aspect, the present disclosure provides a readable storage medium, storing instructions; wherein the instructions are configured to be executed to perform any of the methods in the first aspect and in the second aspect.

### BRIEF DESCRIPTION OF THE DRAWINGS

In order to more clearly explain the embodiments of the present disclosure or the technical solutions in the prior art, the following will briefly introduce the drawings required in the description of the embodiments or the prior art. Obviously, the drawings in the following description are only some embodiments of the present disclosure. For a person skilled in the art, without paying any creative work, other drawings can be obtained according to the structures shown in these drawings.

FIG. 1 is a structural schematic view of a wireless communication system or a wireless communication network according to an embodiment of the present disclosure.

FIG. 2 is a flow chart of a method for transmitting a point-to-multipoint configuration according to an embodiment of the present disclosure.

FIG. 3 a schematic view of three examples of radio resources assigned for the PTM configuration in the method shown in FIG. 2.

FIG. 4 a schematic view of three examples of search spaces assigned for the PTM configuration in the method shown in FIG. 2.

FIG. 5 is a flow chart of a method for transmitting a point-to-multipoint configuration according to another embodiment of the present disclosure.

FIG. 6 is a structural schematic view of an apparatus for transmitting a point-to-multipoint configuration according to an embodiment of the present disclosure.

FIG. 7 is a structural schematic view of an apparatus for transmitting a point-to-multipoint configuration according to another embodiment of the present disclosure.

FIG. 8 is a structural schematic view of a readable storage medium according to an embodiment of the present disclosure.

### DETAILED DESCRIPTION

To make any one of skill in the art to understand the technical solutions of the present disclosure, the method for transmitting a point-to-multipoint configuration and the apparatus thereof, and the readable storage medium provided by the present disclosure will be described in details by referring to the drawings and the embodiments. The ones in the following embodiments that do not conflict with each other may be combined with each other.

The term of “user equipment” in the present disclosure may include or represent any portable computing device for communication. In some embodiments of the described device, method, and system, applicable user equipments (UEs) may be wired or wireless devices, such as mobile devices, mobile phones, terminals, smart phones, portable computing devices such as laptops, handheld devices, tablets, tablet computers, netbooks, personal digital assistants, music players, and other computing devices capable of wired or wireless communication.

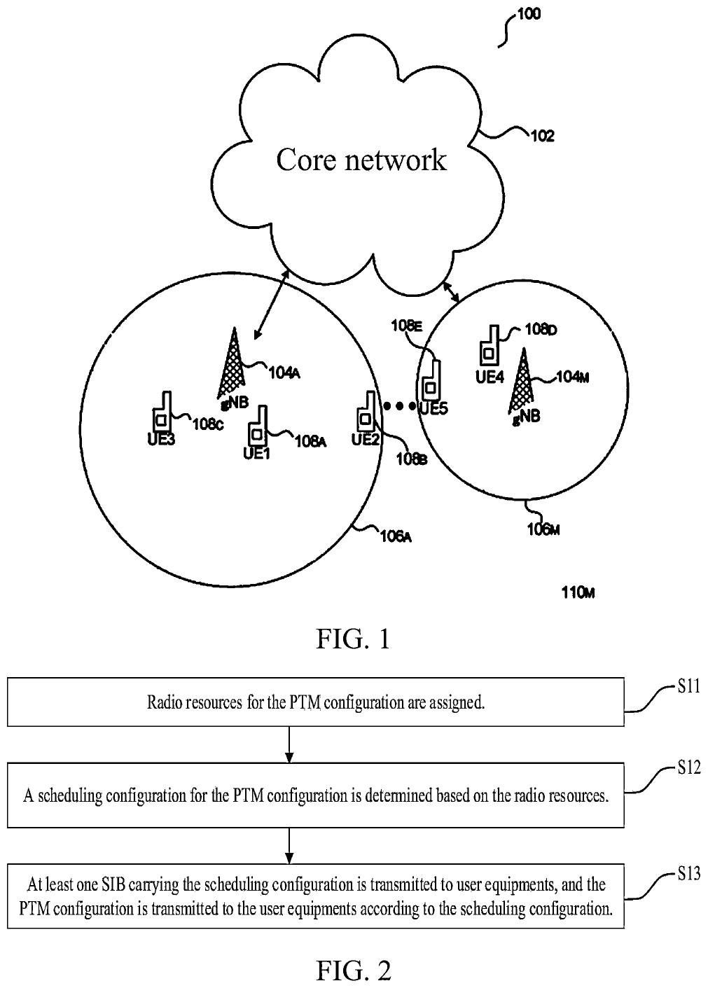

FIG. 1 is a structural schematic view of a wireless communication system or network 100 that includes a core network 102 (or telecommunications infrastructure) with a plurality of network nodes 104a-104m (e.g., base stations gNB) serving a plurality of wireless communication units 108a-108c (e.g., UEs) in cells 106a-106m. The plurality of network nodes 104a-104m are connected to the core network (CN) 102 via links. The links may be wired or wireless (e.g., radio communication links, fiber optics, etc.). The core network 102 may include a plurality of core network nodes, network entities, application servers, or any other network or computing device that may communicate with one or more wireless access networks including the plurality of network nodes 104a-104m.

In some embodiments, the network nodes 104a-104m are base stations, such as, but not limited to, gNB in a 5G network. Each of the plurality of network nodes 104a-104m (e.g., base stations) has a footprint. For example, as shown schematically in FIG. 1 for simplicity, the footprint may refer to the corresponding circular cells 106a-106m serving one or more UE 108a-108c. The UEs 108a-108e are capable of receiving services, such as voice, video, audio, or other communication services, from the wireless communication system 100.

The wireless communication system or network 100 may include or represent any one or more communication networks for communication between the UEs 108a-108e and other devices, content sources, or servers connected to the wireless communication system or network 100. The core network 102 may also include or represent a link, coupling, or connection to form one or more communication networks, one or more network nodes, entities, elements, application servers, servers, base stations, or other network devices of the wireless communication system or network 100. The link or coupling between the network nodes may be wired or wireless (e.g., radio communication links, fiber optics, etc.). The wireless communication system or network 100 and the core network 102 may include: any suitable combination of core networks containing network nodes or entities and wireless access networks, base stations, access points, etc., which enable the UEs 108a-108c, the network nodes 104a-104m of the wireless communication system 100 and the core network 102, content sources, and/or other devices connected to the wireless communication system or network 100 to communicate with each other.

In some embodiments of the described device, method, and system, applicable wireless communication networks 100 may be at least one communication network or a combination thereof, including but not limited to one or more wired and/or wireless telecommunications networks, one or more core networks, one or more wireless access networks, one or more computer networks, one or more data communication networks, Internet, telephone networks, wireless networks such as WiMAX, WLAN and/or Wi-Fi networks based on an IEEE802.11 standard as an example only, or Internet Protocol (IP) networks, packet-switched networks or enhanced packet-switched networks, IP Multimedia Subsystems. (IMS) networks or communication networks based on wireless, cellular or satellite technologies such as mobile networks, Global System for Mobile Communications (GSM), GPRS networks, Wideband Code Division Multiple Access (W-CDMA), CDMA2000 or LTE/Advanced LTE communication networks or any second, third, fourth or fifth generation and beyond type of communication networks etc..

As shown in FIG. 1, the wireless communication system 100 may be a 5G communication network using cyclic prefix orthogonal frequency division multiplexing (CP-OFDM) technology for downlink and uplink channels network. The downlink may include one or more communication channels for transmitting data from one or more gNB 104a-104m to one or more UE 108a-108c. Typically, the downlink channel is a communication channel for transmitting data, e.g., from gNB 104a to UE 108a.

Referring to FIG. 2, FIG. 2 is a flow chart of a method for transmitting a point-to-multipoint configuration according to an embodiment of the present disclosure. The present method may be executable in a base station. The method may include operations at blocks as followed.

At block S11: Radio resources for the PTM configuration are assigned.

The base station may assign radio resources for the PTM configuration. The PTM configuration may include scheduling information of a multicast control channel (MCCH) and/or a multicast transmission channel (MTCH).

The following are examples of the radio resources assigned for the PTM configuration information in conjunction with drawings.

Specifically, the base station may assign first radio resources for the PTM configuration. A bandwidth part (BWP) in which the first radio resources are located is different from an initial downlink BWP. The initial downlink BWP refers to a BWP in which control resource zero (CORSET0) is located. The CORESETO is a CORESET scheduling system information block1 (SIB1). A subcarrier spacing of the BWP in which the first radio resources are located and a subcarrier spacing of the initial downlink BWP are same. A cyclic prefix of the BWP in which the first radio resources are located and a cyclic prefix of the initial downlink BWP are same.

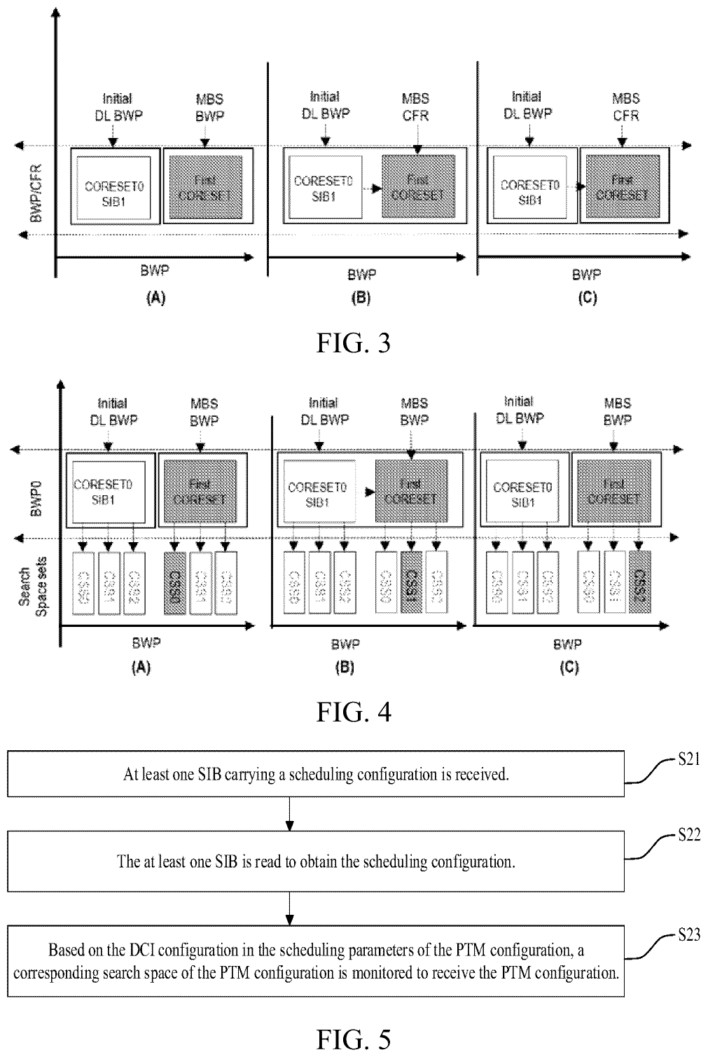

As shown in (A) in FIG. 3, the first radio resources may be a BWP different from the initial downlink BWP and having the same subcarrier spacing and cyclic prefix as the initial BWP for MCCH channel transmission.

In some embodiments, as shown in (B) in FIG. 3, the radio resources may be common frequency resources (CFRs) located in the initial downlink BWP and indicated by the CORSET0 or the SIB1. Specifically, the CFRs may be with a smaller size than the initial BWP. The initial BWP may have the same frequency resources as CORESETO. The CFRs may be configured by SIB1 or DCI scheduled in the CORESETO.

In some embodiments, as shown in (C) in FIG. 3, the radio resources may be CFRs equal to the initial downlink BWP and indicated by the CORSET0 or the SIB1. Specifically, the CFRs may be with the same size as the initial BWP. The CFRs may have the same frequency resources and same subcarrier spacing and cyclic prefix as the initial BWP. The initial BWP may have the same frequency resources as the CORESETO. The CFRs may be equal to the initial downlink BWP, which may be configured by the SIB1 or the DCI scheduled in the CORESETO.

Since the MCCH/MTCH is similar to other common control channels and is transmitted to the UEs in a point-to-multipoint manner, the PTM configuration may share the radio resources with the configuration information of at least one other common control channel. The at least one other common control channel may include at least one of a broadcast control channel (BCCH) and a paging control channel (PCCH). The configuration information of the at least one other common control channel may include system information (SI) and/or paging messages. In this way, the UEs may receive MCCH/MTCH and other common control channels without switching the BWP, thus reducing the signaling overhead of the base station and the UEs.

At block S12: A scheduling configuration for the PTM configuration is determined based on the radio resources.

The scheduling configuration may include a first control resource set (CORESET) and a combination of scheduling parameters for scheduling the PTM configuration and the configuration of each of the at least one other common control channel. The combination of scheduling parameters may include scheduling parameters of the PTM configuration and scheduling parameters of the configuration of each of the at least one other common control channel. The scheduling parameters may include at least one set of a search space and a downlink control information (DCI) configuration. The first CORESET may be located in the wireless resources assigned for the PTM configuration, and size of which may be less than or equal to the wireless resources.

The details of the scheduling parameters of the PTM configuration are illustrated below with examples from the accompanying drawings and tables.

In some embodiments, the search space corresponding to the PTM configuration is a common search space (CSS) with index 0 in the first CORESET. As shown in (A) in FIG. 4, the base station may assign the CSS indexed with zero (CSS 0) for the PTM configuration and others CSSs for SI (i.e., BCCH channel) and/or paging (i.e., PCCH channel).

In some embodiments, the search space corresponding to the PTM configuration is a CSS, of which index is not 0, in the first CORESET. As shown in (B) in FIG. 4, the base station may assign the CSS indexed with one (CSS 1) for the PTM configuration and others CSSs for SI (i.e., BCCH channel) and/or paging (i.e., PCCH channel). As shown in (C) in FIG. 4, the base station may assign the CSS indexed with two (CSS 2) for the PTM configuration and others CSSs for SI (i.e., BCCH channel) and/or paging (i.e., PCCH channel).

For the SI and/or paging messages, the corresponding search spaces and DCIs configuration may be almost known by the UEs. Detailed configuration may be as followed.

Specifically, for SI: A Type0 configured by a master system information block (MIB) or by SIB1 for a remaining minimum system information (RMSI) and/or a Type0A configured by other SI search space in a common physical downlink control channel (PDCCH) configuration for other system information (OSI) with a DCI format 1_0 scrambled by a SI-radio network temporary identity (SI-RNTI).

For paging: A Type2 CSS set configured by paging search space in the common PDCCH configuration for the DCI format 1_0 scrambled by a paging-RNTI (P-RNTI).

As PTM configuration are also broadcasted to a group of UEs similar to the SI and paging, the base station may configure the UEs with the following search space types for PTM configurations.

An example of search space types for PTM configuration may be shown in the Table 1.

TABLE 1

| | | Scrambling | DCI | |
|---|---|---|---|---|
| Type | | RNTI | format | Configured by |
| Common | Type0A | MCCH -RNTI | 1_0 | Search Space Other |
| Search | | | | System Information |
| Space | Type0X | MCCH -RNTI | 1_0 | New search space |
| CSS | | | | for MBS-SIB/MCCH |
| | | | | that carries |
| | | | | MCCH/ PTM |
| | | | | configuration |
| | Type3/ | G-RNTI | 1_0 | Search Space with |
| | New Type | | | a search space |
| | | | | type equal to |
| | | | | common |

An example of the configuration of the RNTI values in Table 1 may be shown in Table 2.

TABLE 2

| | | Scheduling | Value | |
|---|---|---|---|---|
| RNTI | DCI format | Application | hex | decimal |
| MCCH-RNTI | 1_0 | PDSCH for PTM | FFPD | 65533 |
| | | control information | | |
| | | configuration on | | |
| | | MCCH | | |
| G-RNTI | 1_0 | PDSCH for PTM | 0001 to | 0001- |
| | | dynamic transmission | FFEF | 65519 |
| | | on MTCH | | |

In some embodiments, the search space corresponding to the scheduling information of the MCCH is the Type-OA CSS, including PDCCH candidates. The PDCCH candidates may start at the beginning of the search space. The search space corresponding to the scheduling information of the MCCH is configured with the DCI format 1_0 scrambled by a MCCH-RNTI, and may be configured to schedule a group common physical downlink shared channel (gc-PDSCH) carrying the MCCH channel. The search space and/or the DCI configuration corresponding to the scheduling information of the MCCH may be configured by other system information search space within the common PDCCH configuration.

In some embodiments, the search space corresponding to the scheduling information of the MCCH is a new Type-0X CSS, including PDCCH candidates. The PDCCH candidates may start at the beginning of the search space. The X herein is an integer. The search space corresponding to the scheduling information of the MCCH is configured with the DCI format 1_0 scrambled by the MCCH-RNTI, and may be configured to schedule the gc-PDSCH carrying the MCCH channel. The search space and/or the DCI configuration corresponding to the scheduling information of the MCCH may be configured by a new search space defined within the common PDCCH configuration for PTM.

A fixed value of FFFD hexadecimal or 65533 decimal may be assigned for the MCCH-RNTI to scramble the DCI format 1_0 of the search space TypeOA or TypeOX for scheduling the PDSCH carrying PTM control information configuration message on the MCCH channel.

In some embodiments, the search space corresponding to the scheduling information of the MTCH is a Type 3 or a new type of CSS, including group common PDCCH candidates. The PDCCH candidates may start at the beginning of the search space. The search space corresponding to the scheduling information of the MTCH is configured with the DCI format 1_0 scrambled by a group-RNTI (G-RNTI), and may be configured to schedule the gc-PDSCH carrying the MTCH channel. The search space and/or the DCI configuration corresponding to the scheduling information of the MTCH may be configured by a search space with a search space type equal to common.

Any available fixed value within the range between 0001 to FFEF hexadecimal or 0001-65519 decimal may be assigned for the G-RNTI to scramble the DCI format 1_0 of the search space Type3/new type for dynamically scheduling of the PDSCH carrying PTM dynamic transmission on the MTCH.

In the above examples, the PTM configuration may have independent scheduling parameters. That is, the index, type of the search space and DCI configuration of the PTM configuration are different from the configuration information of the other control channel, thereby allowing the UEs to perform regular idle activities e.g. paging, BCCH updates and emergency service while receiving of the MBS indicated on the MCCH.

In some embodiment, to enable the UEs in a radio resource control (RRC) idle state and the UEs in a connected mode to receive without BWP switching, downlink reception type combination in different RRC states may be configured to the UEs, as shown in the Table 3.

TABLE 3

| | Supported reception |
|---|---|
| RRC state | type combination |
| RRC IDLE/inactive UE | A + B + |
| | (C1 and/or C2) |
| Connected mode UE | A + B + |
| | (C0 and/or C1 |
| | and/or C2) |

Detailed configuration of the reception type in the Table 3 may be shown in the Table 4.

TABLE 4

| | | Associated | Associated | |
|---|---|---|---|---|
| Reception | | logical | transport | Physical |
| type | RNTI | Channel | Channel | channel |
| A | — | BCCH | BCH | PBCH |
| B | SI-RNTI | BCCH | DL-SCH | PDCCH + |
| | | | | PDSCH |
| C0 | P-RNTI | PCCH− | — | PDCCH |
| C1 | P-RNTI | PCCH | PCH | PDCCH + |
| | | | | PDSCH |
| C2 | MCCH- | MCCH/ | DL-SCH/ | gc-PDCCH+ |
| | RNTI/G-RNTI | MTCH | MCH | gc-PDSCH] |

The abbreviations in Table 4 are explained as follows. RRC: radio resource control; PDCCH: physical downlink control channel; PDSCH: physical downlink shared channel; DL-SCH: downlink-shared channel; MCH: multicast channel; BCH: broadcast channel; gc-PDCCH: group common physical downlink control channel; gc-PDSCH: physical downlink shared channel; PBCH: physical broadcast channel.

At block S13: At least one system information block (SIB) carrying the scheduling configuration is transmitted to user equipments, and the PTM configuration is transmitted to the user equipments according to the scheduling configuration.

It is to be noted that the SIB and the PTM configuration may be transmitted by multicast or broadcast.

Referring to FIG. 5, FIG. 5 is a flow chart of a method for transmitting a point-to-multipoint configuration according to another embodiment of the present disclosure. The present method can be executable in one or more UEs. The method may include operations at blocks as followed.

At block S21: At least one system information block (SIB) carrying a scheduling configuration is received.

At block S22: The at least one SIB is read to obtain the scheduling configuration.

The scheduling configuration may include a first control resource set (CORESET) and a combination of scheduling parameters for scheduling the PTM configuration and a configuration of each of at least one other common control channel. The at least one other common control channel may include at least one of a broadcast control channel (BCCH) and a paging control channel (PCCH). The combination of scheduling parameters may include scheduling parameters of the PTM configuration and scheduling parameters of the configuration of each of the at least one other common control channel. The scheduling parameters may include at least one set of a search space and a downlink control information (DCI) configuration.

For description related to the scheduling configuration and the PTM configuration, reference may be made to the method for transmitting a PTM configuration as described in the foregoing embodiments of the present disclosure, which will not be explained again.

At block S23: Based on the DCI configuration in the scheduling parameters of the PTM configuration, a corresponding search space of the PTM configuration is monitored to receive the PTM configuration.

The PTM configuration may include scheduling information of a multicast control channel (MCCH) and/or a multicast transmission channel (MTCH).

The UEs may receive the PTM configuration in an RRC connected state, or in an RRC idle state or an inactive state.

After receiving the scheduling information of the MCCH, the UEs may try receiving the MCCH based on/according to the scheduling information. After obtaining the MCCH, the UEs may read the scheduling information of the corresponding MTCH from it. Then the UEs may monitor a corresponding search space to receive the scheduling information of the MTCH based on/according to the DCI configuration in the scheduling parameters of the scheduling information of the MTCH, thereby obtaining the MTCH carrying the MBS.

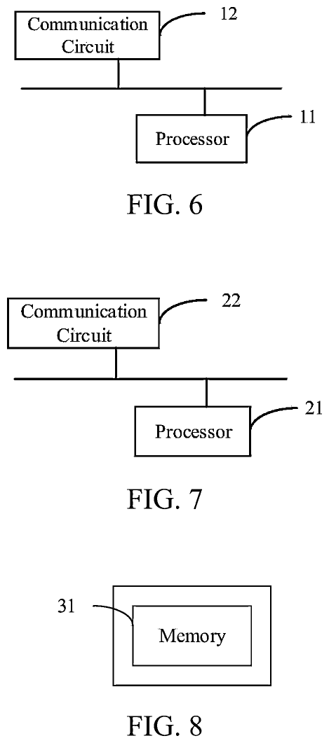

Referring to FIG. 6, FIG. 6 is a structural schematic view of an apparatus for transmitting a point-to-multipoint configuration according to an embodiment of the present disclosure. The apparatus includes a processor 11 and a communication circuit 12; the processor 11 is connected to the communication circuit 12, and the processor 11 is configured to execute instructions to implement the method mainly illustrated in FIG. 2.

The processor 11 may include one or more instances of a processing circuit, i.e., a central processing unit (CPU), a processing unit, a processing circuit, a processor, an application specific integrated circuit (ASIC), a microprocessor, or other processing logic that may interpret and execute instructions. The herein utilized expression “processor” may thus represent a processing circuitry including a plurality of processing circuits, such as, e.g., any, some or all of the ones enumerated above.

Referring to FIG. 7, FIG. 7 is a structural schematic view of an apparatus for transmitting a point-to-multipoint configuration according to another embodiment of the present disclosure. The apparatus includes a processor 21 and a communication circuit 22; the processor 21 is connected to the communication circuit 22, and the processor 21 is configured to execute instructions to implement the method mainly illustrated in FIG. 5.

The processor 21 may include one or more instances of a processing circuit, i.e., a central processing unit (CPU), a processing unit, a processing circuit, a processor, an application specific integrated circuit (ASIC), a microprocessor, or other processing logic that may interpret and execute instructions. The herein utilized expression “processor” may thus represent a processing circuitry including a plurality of processing circuits, such as, e.g., any, some or all of the ones enumerated above.

Referring to FIG. 8, FIG. 8 is a structural schematic view of a readable storage medium according to an embodiment of the present disclosure. The readable storage medium may include a memory 31. The memory 31 can store instructions which are configured to be executed to perform the method proposed by any embodiment of the method for transmitting a PTM configuration according to the present disclosure.

The memory 31 may be a read-only memory (ROM), a random-access memory (RAM), a flash memory, a hard disk, or an optical disk, etc.

It can be appreciated that the apparatuses and methods disclosed herein can also be implemented in other forms. Rather, the apparatuses as described are merely illustrative. For example, the division of modules or units is performed solely based on logic functions, thus in actual implementations there may be other division methods, e.g., multiple units or components may be combined or integrated onto another system, or some features may be ignored or simply not executed. In addition, mutual couplings, direct couplings, or communications connections as displayed or discussed may be achieved through some interfaces, devices, or units, and may be achieved electrically, mechanically, or in other forms.

Separated units as described may or may not be physically separated. Components displayed as units may or may not be physical units, and may reside at one location or may be distributed to multiple networked units. Part or all of the units may be selectively adopted according to actual requirements to achieve objectives of the disclosure.

Additionally, various functional units described herein may be integrated into one processing unit or may be present as a number of physically separated units, and two or more units may be integrated into one. The integrated units may be implemented by hardware or as software functional units.

If the integrated units are implemented as software functional units and sold or used as standalone products, they may be stored in a computer readable storage medium. On the basis of such an understanding, the essential technical solution or all or part of the technical solution of the disclosure may be embodied as software products. Computer software products can be stored in a storage medium and can include multiple instructions enabling a computing device (e.g., a personal computer, a server, a network device, etc.) or a processor to execute all or part of the methods as described in the disclosure. The storage medium may include all kinds of media that can store program codes, such as a USB flash disk, mobile hard drive, read-only memory (ROM), random access memory (RAM), magnetic disk, or optical disk.

The above description merely illustrates some exemplary embodiments of the present disclosure, which however are not intended to limit the scope of the disclosure to these specific embodiments. Any equivalent structural or flow modifications or transformations made to the present disclosure, or any direct or indirect applications of the present disclosure on any other related fields, shall all fall in the scope of the present disclosure.

1. A method for transmitting a point-to-multipoint (PTM) configuration executable in a base station, comprising:
assigning radio resources for the PTM configuration; wherein the PTM configuration comprises scheduling information of a multicast control channel (MCCH) and/or a multicast transmission channel (MTCH);
determining a scheduling configuration for the PTM configuration based on the radio resources; wherein the scheduling configuration comprises a first control resource set (CORESET) and a combination of scheduling parameters for scheduling the PTM configuration and a configuration of each of at least one other common control channel.

2-7. (canceled)

8. The method of claim 1, wherein
the search space corresponding to the scheduling information of the MCCH is a new Type-0X common search space (CSS), comprising physical downlink control channel (PDCCH) candidates, configured with the DCI format [1_0] scrambled by a MCCH-radio network temporary identity (MCCH-RNTI).

9. The method of claim 8, wherein the value of the MCCH-RNTI is fixed at 65533.

10-11. (canceled)

12. A method for transmitting a point-to-multipoint (PTM) configuration executable in user equipments, comprising:
receiving at least one system information block (SIB) carrying a scheduling configuration; wherein the scheduling configuration comprises a configuration of a radio resource for PTM configuration, a combination of scheduling parameters for a PTM configuration and a configuration of at least one other common control channel; wherein the other common control channel comprises at least one of a broadcast control channel and a paging control channel, and the PTM configuration comprises scheduling information of a multicast control channel (MCCH) and/or a multicast transmission channel (MTCH);
reading the at least one SIB to obtain the scheduling configuration; wherein the scheduling configuration comprises a first control resource set (CORESET) and a combination of scheduling parameters for scheduling the PTM configuration and a configuration of each of at least one other common control channel; the at least one other common control channel comprises at least one of a broadcast control channel (BCCH) and a paging control channel (PCCH); the combination of scheduling parameters comprises scheduling parameters of the PTM configuration and scheduling parameters of the configuration of each of the at least one other common control channel, the scheduling parameters comprising at least one set of a search space and a downlink control information (DCI) configuration; and
based on the DCI configuration in the scheduling parameters of the PTM configuration, monitoring a corresponding search space of the PTM configuration to receive the PTM configuration; wherein the PTM configuration comprises scheduling information of a multicast control channel (MCCH) and/or a multicast transmission channel (MTCH).

13-14. (canceled)

15. The method of claim 12, wherein radio resources for the PTM configuration are common frequency resources (CFRs) equal to an initial downlink BWP and indicated by control resource zero (CORSET0) or system information block1 (SIB1).

16-17. (canceled)

18. The method of claim 12, wherein
the search space corresponding to the scheduling information of the MCCH is a new Type-0X common search space (CSS), comprising physical downlink control channel (PDCCH) candidates, configured with the DCI format [1_0] scrambled by a MCCH-radio network temporary identity (MCCH-RNTI).

19. The method of claim 18, wherein the value of the MCCH-RNTI is fixed at 65533.

20-22. (canceled)

23. An apparatus for transmitting a point-to-multipoint (PTM) configuration, comprising a processor and a communication circuit connected to the processor; wherein the processor is configured to execute instructions to perform a method for transmitting a point-to-multipoint (PTM) configuration executable in a base station, comprising:
assigning radio resources for the PTM configuration; wherein the PTM configuration comprises scheduling information of a multicast control channel (MCCH) and/or a multicast transmission channel (MTCH);
determining a scheduling configuration for the PTM configuration based on the radio resources; wherein the scheduling configuration comprises a first control resource set (CORESET) and a combination of scheduling parameters for scheduling the PTM configuration and a configuration of at least one other common control channel.

24-25. (canceled)

26. The method of claim 1, wherein the at least one other common control channel comprises at least one of a broadcast control channel (BCCH) and a paging control channel (PCCH), and the PTM configuration comprises scheduling information of a multicast control channel (MCCH) and/or a multicast transmission channel (MTCH).

27. The method of claim 1, wherein the scheduling parameters comprises at least one set of a search space and a downlink control information (DCI) configuration.

28. The method of claim 1, further comprising transmitting at least one system information block (SIB) carrying the scheduling configuration to at least one radio resource control (RRC) connected mode user equipment, and transmitting the PTM configuration to the at least one RRC connected mode user equipment according to the scheduling configuration.

29. The method of claim 1, wherein the radio resources for the PTM configuration are common frequency resources (CFRs) equal to an initial downlink BWP and indicated by control resource zero (CORSET0) or system information block1 (SIB1).

30. The method of claim 12, wherein the scheduling parameters comprises at least one set of a search space and a downlink control information (DCI) configuration.

31. The method of claim 12, wherein the radio resources for the PTM configuration are common frequency resources (CFRs) equal to an initial downlink BWP and indicated by control resource zero (CORSET0) or system information block1 (SIB1).

32. The apparatus of claim 23, wherein the search space corresponding to the scheduling information of the MCCH is a new Type-0X common search space (CSS), comprising physical downlink control channel (PDCCH) candidates, configured with the DCI format scrambled by a MCCH-radio network temporary identity (MCCH-RNTI).

33. The apparatus of claim 23, wherein the value of the MCCH-RNTI is fixed at 65533.

34. The apparatus of claim 23, wherein the at least one other common control channel comprises at least one of a broadcast control channel (BCCH) and a paging control channel (PCCH), and the PTM configuration comprises scheduling information of a multicast control channel (MCCH) and/or a multicast transmission channel (MTCH).

35. The apparatus of claim 23, wherein the scheduling parameters comprises at least one set of a search space and a downlink control information (DCI) configuration.

36. The apparatus of claim 23, wherein the method further comprises transmitting at least one system information block (SIB) carrying the scheduling configuration to at least one radio resource control (RRC) connected mode user equipment, and transmitting the PTM configuration to the at least one RRC connected mode user equipment according to the scheduling configuration.

37. The apparatus of claim 23, wherein the radio resources for the PTM configuration are common frequency resources (CFRs) equal to an initial downlink BWP and indicated by control resource zero (CORSET0) or system information block1 (SIB1).
